(19) United States
(12) Patent Application Publication
(10) Pub. No.: US 2014/0116102 A1
(43) Pub. Date: May 1, 2014

(54) LOCK STRUCTURE

(71) Applicant: Taiwan Fu Hsing Industrial Co., Ltd., Kaohsiung City (TW)

(72) Inventors: Shih-Min Lu, Kaohsiung City (TW); Chi-Ming Chen, Kaohsiung City (TW)

(73) Assignee: Taiwan Fu Hsing Industrial Co., Ltd., Kaohsiung City (TW)

(21) Appl. No.: 14/066,735

(22) Filed: Oct. 30, 2013

(30) Foreign Application Priority Data
Nov. 1, 2012 (TW) 101221193

(51) Int. Cl. E05B 27/00

(52) U.S. Cl. CPC E05B 27/0057
USPC 70/358

(57) ABSTRACT

A lock structure includes a lock cylinder, a plug and a pin assembly, the plug is within an accommodating space of the lock cylinder. The plug comprises an outer lateral wall, a plurality of first lower pin holes and at least one second lower pin hole, each of the first lower pin holes comprises a first blocking edge, the second lower pin hole comprises a second blocking edge, wherein a second depth defined between the second blocking edge and the outer lateral wall is smaller than a first depth defined between the first blocking edge and the outer lateral wall. By height difference between the position of the first blocking edge and the position of the second blocking edge, an unmatched key can not contact with the second lower pin under instantaneous bump to prevent an unlock situation. Therefore, the burglar proof function is achieved.

### FIELD OF THE INVENTION

The present invention is generally related to a lock structure, which particularly relates to the lock structure lock with burglar proof function.

### BACKGROUND OF THE INVENTION

A conventional lock structure 300 as illustrate in FIGS. 7 and 8 includes a lock cylinder 310, a plug 320, a plurality of springs 330, a plurality of upper pins 340 and a plurality of lower pins 350. The lock cylinder 310 comprises a plurality of upper pin holes 311. The plug 320 is disposed within the lock cylinder 310 and comprises a plurality of lower pin holes 321 and a keyhole 322. Each of the lower pins holes 321 corresponds to each of the upper pins holes 311, wherein each of the springs 330 and each of the upper pins 340 are disposed at each of the upper pin holes 311, and each of the lower pins 350 is disposed at each of the lower pin holes 321. The height of each of the lower pins 350 revealed by the keyhole 322 is consistent from each other. With reference to FIG. 8, when an unmatched key 400 is inserted into the keyhole 322 in a manner of instantaneous bump, owing to the reason that the position of each of the lower pins 350 revealed by the keyhole 322 is consistent from each other, a plurality of teeth 410 of the unmatched key 400 collide with the lower pins 350 to make each of the lower pins 350 bounce upwardly and impact each of the upper pins 340. When a contact surface between each of the upper pins 340 and each of the lower pins 350 is located at a rotation interface defined by the lock cylinder 310 and the plug 320 under instantaneous bump, an unlock situation is occurred as the unmatched key 400 rotates simultaneously, which results in failure of burglar proof function.

### SUMMARY

The primary object of the present invention is to provide a lock structure with burglar proof function. By position inconsistency of blocking edges disposed within lower pin holes, the height of lower pins that is revealed by keyhole will be inconsistent as well. Therefore, using pick tool or unmatched key to unlock lock structure is not applicable so that burglar proof function is achieved.

A lock structure in the present invention includes a lock cylinder, a plug and a pin assembly, wherein the lock cylinder comprises an accommodating space, and the plug is disposed in the accommodating space. The plug comprises an outer lateral wall, a plurality of first lower pin holes, at least one second lower pin hole and a keyhole, each of the first lower pin holes and the at least one second lower pin hole are recessed from the outer lateral wall. Each of the first lower pin holes comprises a first hole surface and a first blocking edge formed at the first hole surface, the at least one second lower pin hole comprises a second hole surface and a second blocking edge formed at the second hole surface, wherein a second depth defined between the second blocking edge and the outer lateral wall is smaller than a first depth defined between the first blocking edge and the outer lateral wall. The pin assembly includes a plurality of first lower pins and at least one second lower pin, each of the first lower pins is disposed at each of the first lower pin holes, and the at least one second lower pin is disposed at the at least one second lower pin hole.

In this invention, for the second depth defined between the second blocking edge and the outer lateral wall is smaller than the first depth defined between the first blocking edge and the outer lateral wall, the height of each of the first lower pins that is revealed by the keyhole is inconsistent comparing with the height of each of the second lower pins that is revealed by the keyhole. When an unmatched key is inserted into the keyhole, the unmatched key can not contact and collide with the second lower pin to prevent an unlock situation. Therefore, the burglar proof function is well achieved. Besides, a variety of lengths of lower pins are producible in automatic production. The production efficiency will not be affected as long as adopting a lower pin with smaller length and putting mentioned lower pin into specific second lower pin hole. Therefore, fabricating different types of lower pins can be avoided.

### DESCRIPTION OF THE DRAWINGS

FIG. 1 is a partial section view of a perspective exploded diagram illustrating a lock structure in accordance with an embodiment of the present invention.

FIG. 2 is a lateral section view illustrating the lock structure in accordance with the embodiment of the present invention.

FIG. 3 is a diagram illustrating an unmatched key to pick the lock structure in accordance with the embodiment of the present invention.

FIG. 4 is a diagram illustrating an action for picking the lock structure in accordance with the embodiment of the present invention.

FIG. 5 is a perspective section view illustrating a matched key inserted into the lock structure in accordance with the embodiment of the present invention.

FIG. 6 is a perspective section view illustrating the matched key to rotate the plug in accordance with the embodiment of the present invention.

FIG. 7 is a lateral section view illustrating an unmatched key inserted into a conventional lock structure.

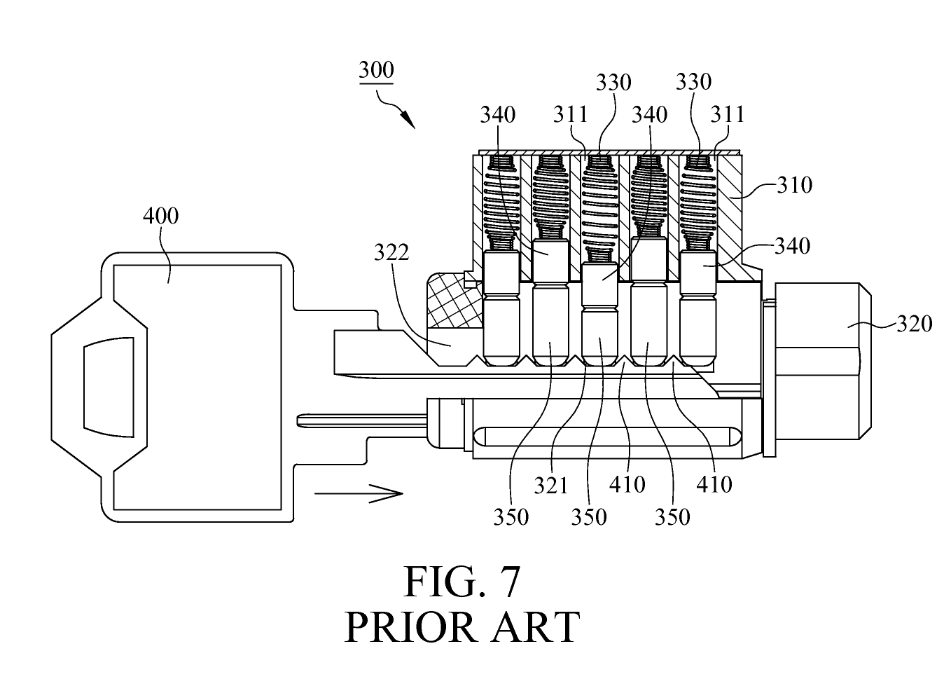

FIG. 8 is a diagram illustrating an unmatched key to pick the conventional lock structure.

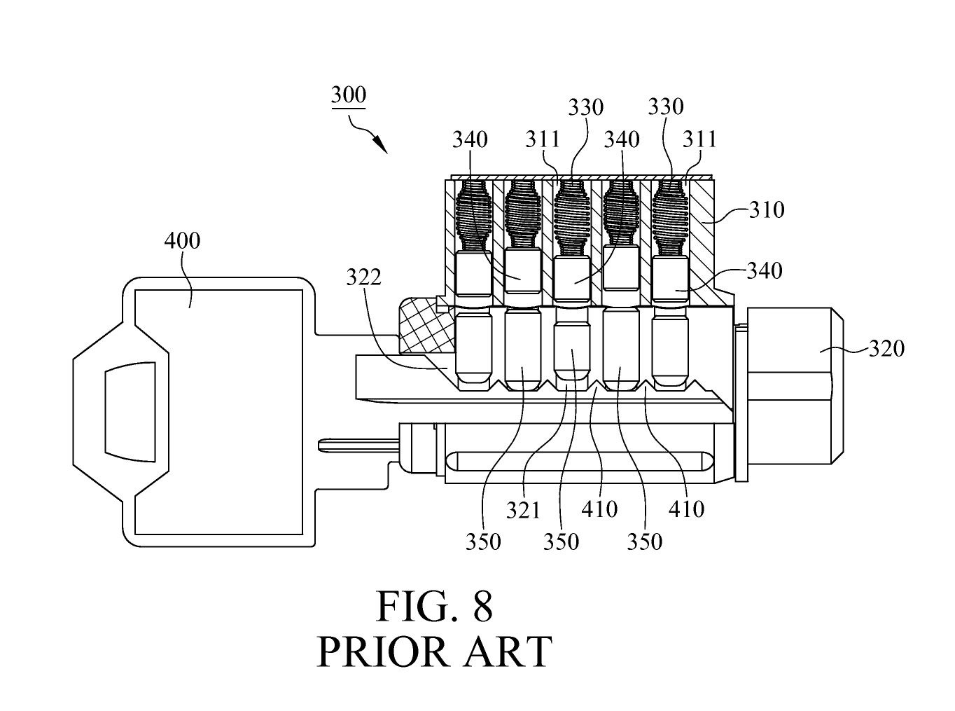

### DETAILED DESCRIPTION OF THE INVENTION

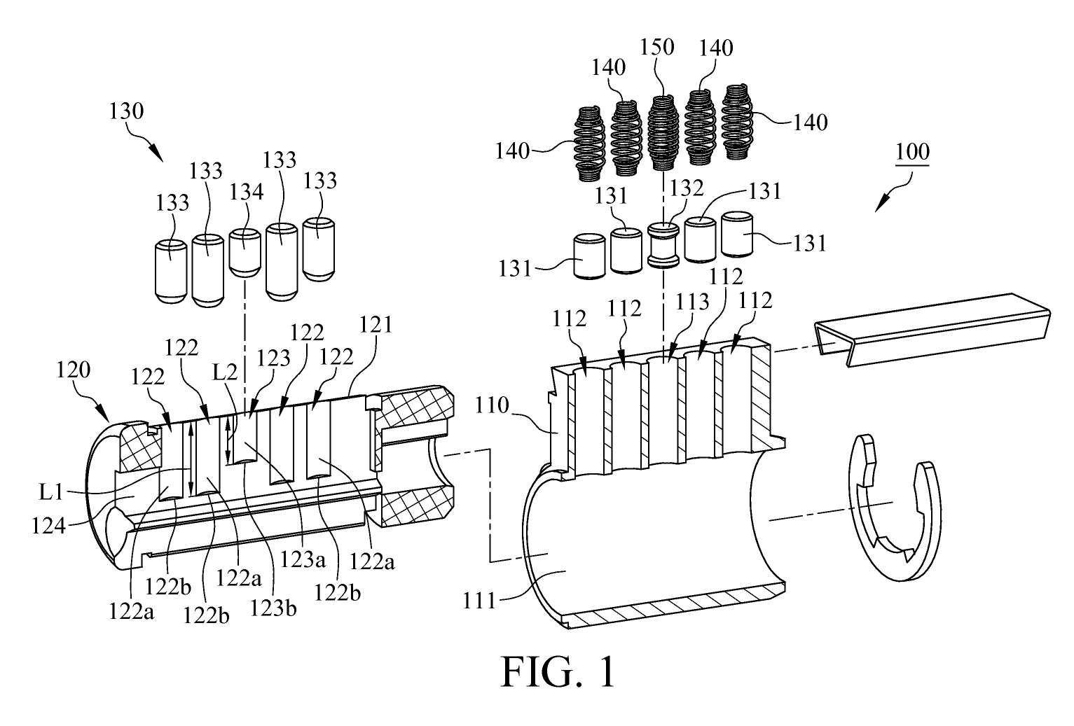

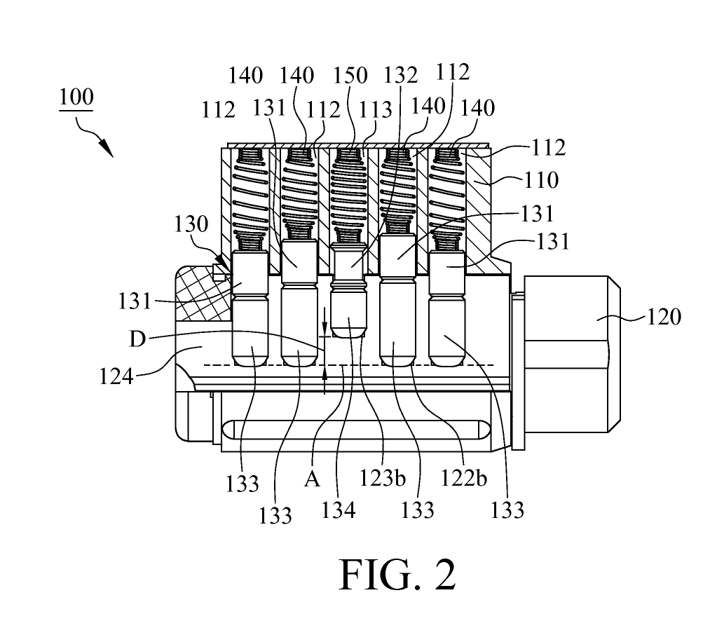

With reference to FIGS. 1 and 2, a lock structure 100 in accordance with an embodiment of the present invention includes a lock cylinder 110, a plug 120, a pin assembly 130, a plurality of first elastic members 140 and at least one second elastic member 150, wherein the lock cylinder 110 comprises an accommodating space 111, a plurality of first upper pin holes 112 and at least one second upper pin hole 113. Each of the first upper pin holes 112 and the second upper pin hole 113 communicate with the accommodating space 111, and the plug 120 is rotatably disposed within the accommodating space 111. The plug 120 comprises an outer lateral wall 121, a plurality of first lower pin holes 122, at least one second lower pin hole 123 and a keyhole 124, wherein each of the first lower pin holes 122 and the second lower pin hole 123 are recessed from the outer lateral wall 121, each of the first lower pin holes 122 communicates with each of the first upper pin holes 112 and the keyhole 124, and the second lower pin hole 123 communicates with the second upper pin hole 113 and the keyhole 124. Each of the first lower pin holes 122 comprises a first hole surface 122a and a first blocking edge 122b formed at the first hole surface 122a, and the second lower pin hole 123 comprises a second hole surface 123a and a second blocking edge 123b formed at the second hole surface 123a. A second depth L2 defined between the second blocking edge 123b and the outer lateral wall 121 is smaller than a first depth L1 defined between the first blocking edge 122b and the outer lateral wall 121. In this embodiment, the first depth L1 ranges from 7 to 7.5 mm, and the second depth L2 ranges from 4.5 to 5.5 mm

With reference to FIGS. 1 and 2, the pin assembly 130 includes a plurality of first upper pins 131, at least one second upper pin 132, a plurality of first lower pins 133 and at least one second lower pin 134, wherein each of the first upper pins 131 is disposed at each of the first upper pin holes 112, the second upper pin 132 is disposed at the second upper pin hole 113, each of the first lower pins 133 is disposed at each of the first lower pin holes 122, each of the first lower pins 133 is blockable by each of the first blocking edges 122b, the second lower pin 134 is disposed at the second lower pin hole 123, and the second lower pin 134 is blockable by the second blocking edge 123b, and the bottom of the at least one second lower pin 134 is not aligned with the bottom of the plurality of first lower pins 133 while no key is inserted into the keyhole 124. In this embodiment, the second upper pin 132 is an I-shaped pin, the length of the second lower pin 134 is smaller than the second depth L2, and usually the pin size of the second lower pin 134 is selected from No. 1, 2 or 3.

With reference to FIG. 2, each of the first elastic member 140 is disposed at each of the first upper pin holes 112, each of the first upper pins 131 is located between each of the first elastic members 140 and each of the first lower pins 133 and pressed by each of the first elastic member 140 to make each of the first upper pins 131 limit the plug 120 from rotation. The second elastic member 150 is disposed at the second upper pin hole 113, the second upper pin 132 is located between the second elastic member 150 and the second lower pin 134 and pressed by the second elastic member 150 to make the second upper pin 132 limit the plug 120 from rotation.

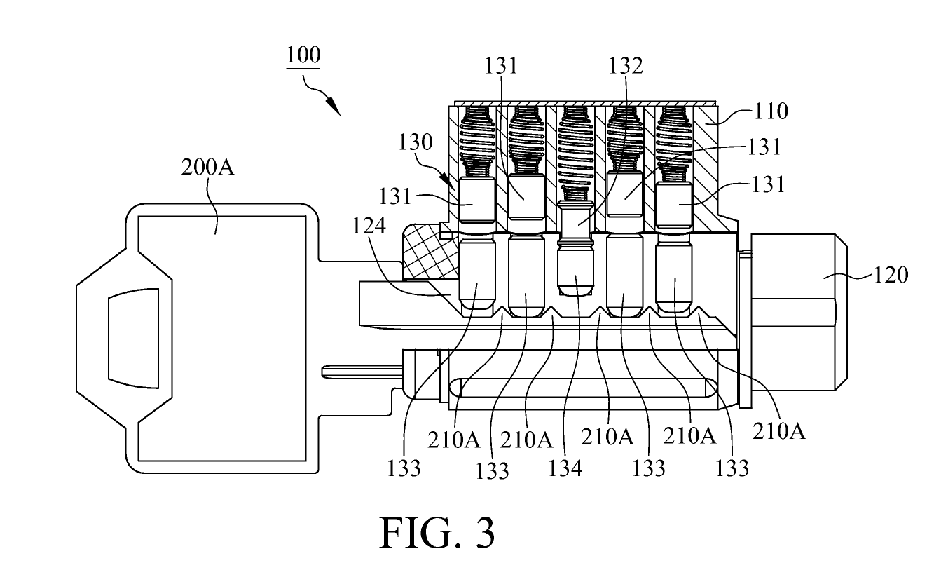

With reference to FIG. 2, in this embodiment, a base line A is extendedly formed by the first blocking edges 122b, wherein the second blocking edge 123b and the base line A are spaced apart from each other to define an interval D, accordingly, the position of the second lower pin 134 is relatively higher than the position of each of the first lower pins 133. Referring to FIG. 3, when an unmatched key 200A is inserted into the keyhole 124 of the plug 120 in a manner of instantaneous bump, for the second depth L2 between the second blocking edge 123b and the outer lateral wall 121 is smaller than the first depth L1 between the first blocking edge 122b and the outer lateral wall 121 resulting in a height inconsistency between the height of each of the first lower pins 133 that is revealed by the keyhole 124 and the height of the second lower pin 134 that is revealed by the keyhole 124, a plurality of teeth 210A of the unmatched key 200A can not contact and collide with the second lower pin 134. Therefore, the second lower pin 134 cannot be bounced upwardly in response to the insertion of the unmatched key 200A in a manner of instantaneously bump. Accordingly, the second upper pin 132 is still located within the second upper pin hole 113 and the second lower pin hole 123 to engage with the second lower pin 134 to prevent the plug 120 from rotating in the lock cylinder 110, thus a burglar proof function is well achieved.

Otherwise, various types of lengths of lower pins are producible in automatic production. The production efficiency will not be affected as long as adopting a lower pin with smaller length and putting mentioned lower pin inside specific second lower pin hole 123. Therefore, fabricating different types of lower pins can be avoided.

In this embodiment, the compressive force of the second elastic member 150 is larger than that of the first elastic member 140. The compressive force of the second elastic member 150 is adjustable by changing rigidity, number of turns or diameter for increasing the compressive force of the second elastic member 150 to make the second upper pin 132 and the second lower pin 134 constrained between the second elastic member 150 and the second blocking edge 123b. Since the second upper pin 132 and the second lower pin 134 are compressed by powerful spring, the second upper pin 132 and the second lower pin 134 are difficult to bounce toward the rotation interface defined between the lock cylinder 110 and the plug 120 therefore achieving burglar proof function.

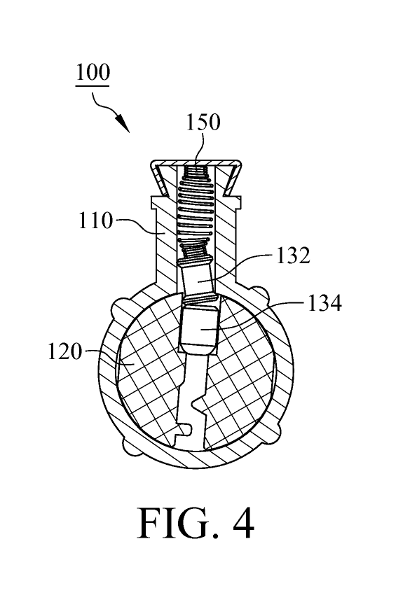

Furthermore, the second upper pin 132 is an I-shaped pin. With reference to FIG. 4, when someone attempts to pick the lock structure 100, the second upper pin 132 is lodged between the lock cylinder 110 and the plug 120 by initial rotation of the plug 120. Therefore, the plug 120 can not rotate lastingly to achieve the burglar proof function.

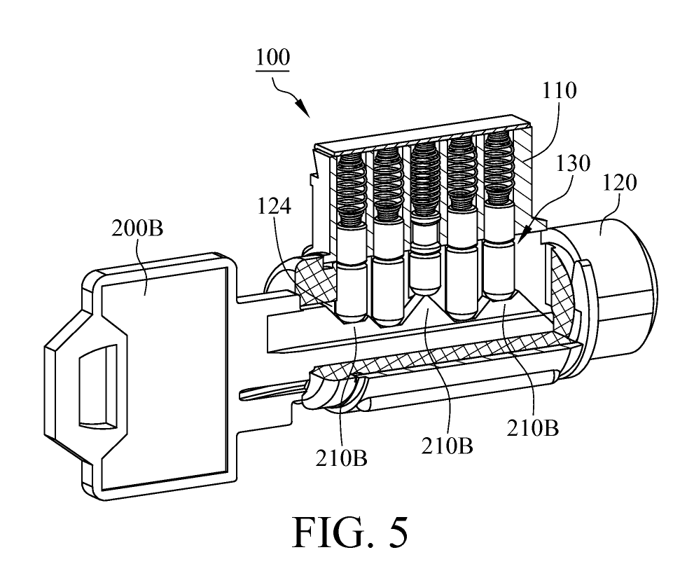

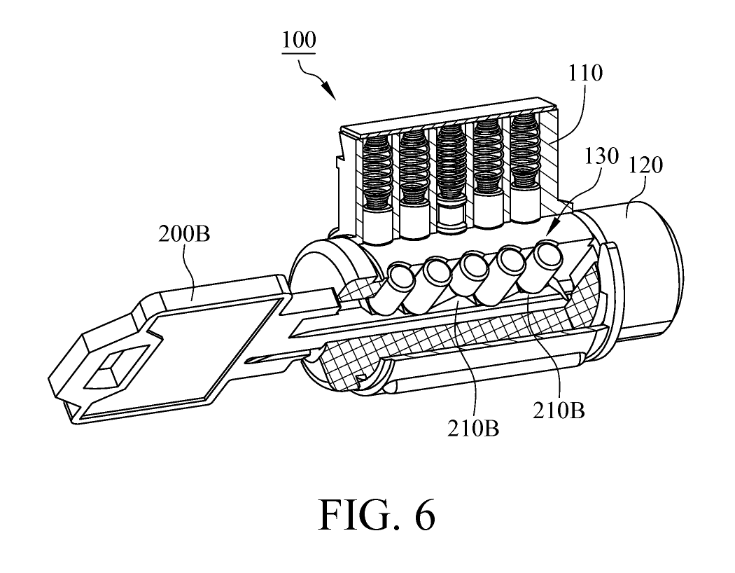

With reference to FIGS. 5 and 6, when a matched key 200B is inserted into the keyhole 124 of the plug 120, a plurality of teeth 210B of the matched key 200B push the first upper pins 131, the second upper pin 132, the first lower pins 133 and the second lower pin 134 to move upwardly to the rotation interface defined between the lock cylinder 110 and the plug 120. Thereafter, rotating the plug 120 by using the matched key 200B completes an unlock action.

In this invention, for the second depth L2 defined from the second blocking edge 123b to the outer lateral wall 121 is smaller than the first depth L1 defined from the first blocking edge 122b to the outer lateral wall 121 therefore resulting in height inconsistency between the height of each of the first lower pins 133 that is revealed by the keyhole 124 and the height of the second lower pin 134 that is revealed by the keyhole 124, any unmatched key can not contact with the second lower pin 134 so that the burglar proof function is well achieved.

While this invention has been particularly illustrated and described in detail with respect to the preferred embodiments thereof, it will be clearly understood by those skilled in the art that it is not limited to the specific features and describes and various modifications and changes in form and details may be made without departing from the spirit and scope of this invention.

What is claimed is:

1. A lock structure includes:
a lock cylinder having an accommodating space;
a plug disposed in the accommodating space and having an outer lateral wall, a plurality of first lower pin holes, at least one second lower pin hole and a keyhole, wherein each of the first lower pin holes and the at least one second lower pin hole are recessed from the outer lateral wall, each of the first lower pin holes comprises a first hole surface and a first blocking edge formed at the first hole surface, the at least one second lower pin hole comprises a second hole surface and a second blocking edge formed at the second hole surface, wherein a second depth defined between the second blocking edge and the outer lateral wall is smaller than a first depth defined between the first blocking edge and the outer lateral wall; and
a pin assembly including a plurality of first lower pins and at least one second lower pin, each of the first lower pins is disposed at each of the first lower pin holes, and the at least one second lower pin is disposed at the at least one second lower pin hole.

2. The lock structure in accordance with claim 1, wherein the lock cylinder further comprises a plurality of first upper pin holes and at least one second upper pin hole, each of the first lower pin holes communicates with each of the first upper pin holes and the keyhole, and the at least one second lower pin hole communicates with the at least one second upper pin hole and the keyhole.

3. The lock structure in accordance with claim 2, wherein the pin assembly further includes a plurality of first upper pins and at least one second upper pin, each of the first upper pins is disposed at each of the first upper pin holes, and the at least one second upper pin is disposed at the at least one second upper pin hole.

4. The lock structure in accordance with claim 1, wherein a base line is extendedly formed by the first blocking edges, wherein the second blocking edge and the base line are spaced apart from each other to define an interval.

5. The lock structure in accordance with claim 3 further includes a plurality of first elastic members and at least one second elastic member, each of the first elastic members is disposed at each of the first upper pin holes, each of the first upper pins is located between each of the first elastic members and each of the first lower pins, the at least one second elastic member is disposed at the at least one second upper pin hole, and the at least one second upper pin is located between the at least one second elastic member and the at least one second lower pin.

6. The lock structure in accordance with claim 5, wherein the compressive force of the at least one second elastic member is larger than the compressive force of each of the first elastic members.

7. The lock structure in accordance with claim 3, wherein the at least one second upper pin is an I-shaped pin.

8. The lock structure in accordance with claim 1, wherein the length of the at least one second lower pin is smaller than the second depth.

9. A lock structure includes:
a lock cylinder having an accommodating space;
a plug disposed in the accommodating space and having a plurality of first lower pin holes, at least one second lower pin hole and a keyhole; and
a pin assembly including a plurality of first lower pins and at least one second lower pin, each of the first lower pins is disposed at each of the first lower pin holes, and the at least one second lower pin is disposed at the at least one second lower pin hole, wherein the bottom of the at least one second lower pin is not aligned with the bottom of the plurality of first lower pins while no key is inserted into the keyhole.

10. The lock structure in accordance with claim 9, wherein the lock cylinder further comprises a plurality of first upper pin holes and at least one second upper pin hole, each of the first lower pin holes communicates with each of the first upper pin holes and the keyhole, and the at least one second lower pin hole communicates with the at least one second upper pin hole and the keyhole.

11. The lock structure in accordance with claim 10, wherein the pin assembly further includes a plurality of first upper pins and at least one second upper pin, each of the first upper pins is disposed at each of the first upper pin holes, and the at least one second upper pin is disposed at the at least one second upper pin hole.

12. The lock structure in accordance with claim 11 further includes a plurality of first elastic members and at least one second elastic member, each of the first elastic members is disposed at each of the first upper pin holes, each of the first upper pins is located between each of the first elastic members and each of the first lower pins, the at least one second elastic member is disposed at the at least one second upper pin hole, and the at least one second upper pin is located between the at least one second elastic member and the at least one second lower pin.

13. The lock structure in accordance with claim 12, wherein the compressive force of the at least one second elastic member is larger than the compressive force of each of the first elastic members.

14. The lock structure in accordance with claim 11, wherein the at least one second upper pin is an I-shaped pin.
